(19) United States
(12) Patent Application Publication
(10) Pub. No.: US 2023/0120620 A1
(43) Pub. Date: Apr. 20, 2023

(54) Method For Evaluating A Sensor-Detectable Transient Pressure Difference On A Gas Boiler And Associated Gas Boiler

(71) Applicant: ebm-papst Landshut GmbH, Landshut (DE)

(72) Inventors: Enno Jan VROLIJK, Dalen (NL); Jens HERMANN, Landshut (DE); Markus WEINGART, Rottenburg (DE); Andreas KERSCHREITER, Eching (DE); Simon BERNHARD, Regensburg (DE)

(21) Appl. No.: 17/968,893

(22) Filed: Oct. 19, 2022

(30) Foreign Application Priority Data
Oct. 20, 2021 (DE) 10 2021 127 224.6

(51) Int. Cl. F24H 15/242; G01L 23/08; F23D 14/02; F23D 14/72; F24H 1/00

(52) U.S. Cl. CPC F24H 15/242; G01L 23/08; F23D 14/02; F23D 14/72; F24H 1/0027

(57) ABSTRACT

A method for evaluating a sensor-detectable transient pressure difference on a gas boiler. The sensor detects a differential pressure at a measurement point upstream of the main flow restrictor (3) and downstream of the control valve (2) and a reference pressure and transmits it to the evaluation electronics. The sensor detects a differential pressure course and transmits it to the evaluation electronics, during variation of heat output and/or when the heat output is adjusted to the predetermined value. The evaluation electronics evaluates the differential pressure course over its time range and/or its frequency range. At least one characteristic value is determined and compared with a predetermined comparison value. If the characteristic value deviates from the comparison value, an error of the gas boiler is recognized.

### CROSS-REFERENCE TO RELATED APPLICATION

This application claims the benefit and priority of Germany Application No. 10 2021 127 224.6, filed Oct. 20, 2021. The entire disclosure of the above application is incorporated herein by reference.

### FIELD

The present disclosure relates to a method to evaluate a sensor-detectable transient pressure difference on a gas boiler and to a gas boiler designed to carry out the method.

### BACKGROUND

In the prior art, gas boilers are known, where a pressure difference is measured upstream of a main flow restrictor, with respect to a reference pressure, by a sensor. The sensor is designed as a differential pressure sensor and the fuel mass flow is regulated based on the pressure difference.

In principle, a gas boiler usually includes, besides additional components, a mixing device, fan, main flow restriction, control valve and a safety valve. The mixing device mixes an inflowing fuel from a fuel inlet and inflowing air from an air inlet to form a fuel-air mixture. The fan suctions the fuel and the air through the mixing device. The main flow restrictor limits a mass flow of the fuel into the mixing device. The control valve is arranged upstream of the main flow restrictor for closed-loop control of a mass flow of the fuel into the mixing device. The safety valve is arranged upstream of the control valve to interrupt the mass flow of the fuel. The gas-air mixture can subsequently be led to a burner, where the mixture can be combusted.

For the closed-loop control of the pressure of the inflowing fuel, the control valves in the prior art often work as mechanical-pneumatic gas valves, a pressure difference is detected by a control diaphragm arranged between two regions of different pressure.

However, alternatively, in the context of a so-called “electronic closed-loop control” pressure sensors are also used, where the pressures are detected by separate sensors. The pressure values are electronically evaluated to determine the pressure difference. Depending on the evaluation, an electronically actuatable control valve or gas valve is open-loop or closed-loop controlled.

In a device for the closed-loop control of the gas-air mixture of a gas boiler, for example, the pressure upstream of the main flow restrictor is measured with respect to a reference pressure using a differential pressure sensor that measures the differential pressure or the pressure difference between two pressure decreases.

Here, an electronic gas valve is usually actuated by a digital controller which, for example, is implemented on a microcontroller or another control device, and by means of which the determined offset pressure or the pressure difference is to be regulated to the desired or predetermined target value.

Since the target value of the pressure or of the pressure difference is usually 0 Pa, the term “electronic zero-pressure control” is often used.

Independently of whether an electronic or mechanical pneumatic closed-loop control is involved, the function is in each case is limited to the closed-loop control of the gas boiler based on the pressure difference without being able to provide additional functionalities.

However, it would be desirable to be able to monitor a gas boiler with respect to additional characteristic values, in order to recognize errors of the gas boiler as a function of characteristic values, and to be able to subject the boiler to open-loop or closed-loop control as a function thereof and also to be able to take additional steps, in particular steps that increase the useful life of the boiler.

To the extent that, in the known gas boilers, additional characteristic values can be detected or errors can be recognized at all, additional sensors and evaluation devices are necessary for this purpose, which is complicated and expensive.

Therefore, the underlying aim of the disclosure is to overcome the aforementioned disadvantages and to provide a method where errors of a gas boiler can be detected and evaluated in a simple and cost-effective way.

### SUMMARY

This section provides a general summary of the disclosure, and is not a comprehensive disclosure of its full scope or all of its features.

This aim is achieved by the combination of features according to a method for evaluating a sensor-detectable transient pressure difference on a gas boiler. The sensor is a differential pressure sensor or a mass flow sensor. The gas boiler includes a mixing device, a fan, a main flow restrictor, control valve and safety valve. The mixing device mixes an inflowing fuel from a fuel inlet and inflowing air from an air inlet to form a fuel-air mixture. The fan suctions the fuel and the air through the mixing device. The main flow restrictor limits a mass flow of the fuel into the mixing device. The control valve is arranged upstream of the main flow restrictor for a closed-loop control of a mass flow of the fuel into a mixing unit. The safety valve, arranged upstream of the control valve, interrupts the mass flow of the fuel. The method detects a differential pressure between a pressure at a measurement point upstream of the main flow restrictor and downstream of the control valve and a reference pressure at a reference measurement point and transmits it to evaluation electronics. The method varies a heat output of the gas boiler according to a predetermined heat output course and/or is adjusted to a predetermined value. The method, detects during the variation of the heat output and/or when the heat output is adjusted to the predetermined value, a differential pressure course and transmits it to the evaluation electronics. The method evaluates, via the evaluation electronics, the differential pressure course over its time range and/or its frequency range and determines at least one characteristic value characterizing the differential pressure course and comparing it with a predetermined comparison value. The method recognizes an error of the gas boiler if the characteristic value deviates from the comparison value beyond a predetermined tolerance value.

Therefore, proposed according to the disclosure is a method for evaluating a sensor-detectable transient pressure on a gas boiler. Here, the sensor is a differential pressure sensor or a mass flow sensor. In particular, a differential pressure sensor can determine the pressure difference between two pressures or between the pressures of two fluids in two regions that are separate from one another, wherein, for this purpose, the differential pressure sensor can also include two separate sensors or pressure transducers. The gas boiler comprises a mixing device, a fan, a main flow restriction, a control valve, a safety valve, a burner and a combustion chamber. The mixing device mixes an inflowing fuel from a fuel inlet and inflowing air from an air inlet to form a fuel-air mixture. The fan suctions the fuel and the air through the mixing device. The main flow restrictor limits a mass flow of the fuel into the mixing device. The control valve, arranged upstream of the main flow restrictor, controls a mass flow of the fuel into the mixing device. The safety valve, arranged upstream of the control valve, interrupts the mass flow of the fuel. The control valve can also be referred to as gas control valve and is preferably actuated by an offset controller which, by actuating the control valve, regulates the desired offset pressure or the desired target value. The fuel-air mixture can be moved, for combustion, into the burner and combustion chamber. According to the disclosure, the sensor detects a differential pressure between a pressure at a measurement point upstream of the main flow restrictor and downstream of the control valve. A reference pressure (for example, environmental pressure or pressure of the inflowing air) is measured at a reference measurement point, arranged in the environment or in an air-carrying line that leads to the mixing device. Moreover, the sensor transmits at least the differential pressure and optionally also the pressure to the measurement point and the reference pressure to evaluation electronics which is preferably designed integrally with control electronics for the closed-loop control of the control valve and which can be implemented, for example, by a microcontroller. According to the method, a heat output of the gas boiler is varied according to a predetermined heat output course and/or adjusted to a predetermined value. Here, during the variation of the heating power and/or when the heating power is adjusted to the predetermined value, the sensor detects a differential pressure course and transmits it to the evaluation electronics. The evaluation electronics evaluates the differential pressure course over its time range and/or its frequency range and determines at least one characteristic value that characterizes the differential pressure course and compares it with a predetermined comparison value. Accordingly, if the characteristic value deviates from the comparison value beyond a predetermined tolerance value, an error of the gas boiler is recognized.

Accordingly, on gas boilers with an electronic zero-pressure control, by the additional evaluation of the differential pressure course, additional functionalities are to be provided, which is not easily possible, for example, in the case of gas boilers with mechanical-pneumatic control valves that regulate the offset pressure with corresponding control diaphragms.

Correspondingly, in the case of such gas boilers with a differential pressure sensor that is usually used for the electronic zero-pressure control, with evaluation electronics, by evaluation of the differential pressure course and, in particular, of the transient pressure signals contained therein, additional process parameters can be determined, states of the gas boiler can be detected and/or checked for plausibility, and errors of the gas boiler or on the gas boiler can be recognized.

In gas boilers, a thermoacoustic effect may occur, if portions of the boiler capable of oscillating (resonators), or portions in the system formed by the gas boiler are capable of oscillating, oscillate in resonance in a marginally stable manner. The system includes, for example, the burner, the combustion chamber, the flame in the combustion chamber for combusting the gas-air mixture, the mixing device, and the gas control valve.

Lean mixtures of air and fuel, in premixed flames, often lead to low-frequency pressure fluctuations on the burner, that can then excite resonators to oscillate. The resonators include, for example, a gas column in the combustion chamber, but also spring-mass systems in the gas control valve.

Even if, in the heating boiler, for example, as a result of a wind gust, the flame becomes unacceptably thin for a brief time, a thermoacoustic effect can occur. Usually, the thermoacoustic effect can be perceived by a loud humming, since the oscillations are often low frequency (10 to 100 Hz).

An advantageous development of the method according to the disclosure provides that the gas boiler further comprises a burner designed to combust the fuel-air mixture, so that, due to the combustion, a thermoacoustic effect in the fuel-air mixture can occur, which, during the combustion, can be detected by the sensor as pressure fluctuations. The evaluation electronics detects the pressure fluctuation and, by analysis of the differential pressure course, recognizes the occurring thermoacoustic effect as a (possibly first) characteristic value.

Preferably the evaluation electronics compares the thermoacoustic effect detected or determined as a characteristic value with a predetermined limit value for the thermoacoustic effect as a comparison value, and, if the limit value is overshot, which is to be equated with an error of the gas boiler, actuates the burner and/or the fan and/or the control valve and/or a safety valve, reducing the thermoacoustic effect and, in particular, reducing the thermoacoustic effect below the limit value.

Thus, in the case of an actually occurring thermoacoustic effect, a triggered pressure fluctuation, which can comprise a high amplitude of several hundred Pa, can be detected and recognized as thermoacoustic effect by an algorithm designed for this purpose.

If a thermoacoustic effect has been recognized, different actions can be carried out:

1) Enriching the fuel-air mixture: A flow of the fuel through the control valve is increased with a predetermined speed, until the thermoacoustic oscillations or the thermoacoustic effect is/are no longer detected. The speed can be set as a function of a GV characteristic line of the control valve and of the speed of rotation of the fan. Subsequently, the control valve is again actuated by a control device provided for this purpose or by a so-called offset pressure controller.

2) Modulating the heat output or a speed of rotation of the fan: The speed of rotation is increased with an active offset pressure controller, in order to approach a different/more stable operating point.

3) Flushing and additional ignition attempts: If an exhaust gas path has been shifted and the thermoacoustic effect occurs in the process, this shifted state can be recognized when the gas boiler is started again.

4) Locking: If the methods mentioned under 1) and 2) are carried out too often within a predetermined time period, the boiler can become locked, i.e., for example, the safety valve can be closed. An occurring thermoacoustic effect can also be an indication of an unsuitable combination of gas type and main flow restrictor, which can thus be recognized.

According to a variant of the method, the fan comprises an impeller and the impeller, by its rotation, generates or can generate pressure fluctuations of the fuel-air mixture which can be detected by the sensor. According to the method, the pressure fluctuations are detected by the evaluation electronics via the frequencies of the differential pressure course. From the frequencies of the differential pressure course, an actual speed of rotation of the impeller is then determined as characteristic value or as an additional or second characteristic value.

Here, according to an advantageous development, the fan comprises a motor which drives the impeller with a motor speed of rotation and the motor speed of rotation corresponds to a target speed of rotation of the impeller. According to the method, the evaluation electronics compares the actual speed of rotation of the impeller determined as characteristic value with the target speed of rotation of the impeller as comparison value. If the actual speed of rotation deviates from the target speed of rotation of the impeller beyond a predetermined tolerance value, it is recognized by the evaluation electronics that the impeller is not connected in a predetermined way to the motor. In concrete terms, a connection between impeller and motor may have become loose, so that the impeller thus deviates in terms of its speed of rotation from the motor speed of rotation, which, as described, can be recognized via the pressure fluctuation.

If it has been recognized that the impeller is not (is no longer) connected in a predetermined way to the motor, this corresponds to an error, whereupon, for example, an error message can be output and/or the gas boiler can be correspondingly actuated. For example, the safety valve and/or control valve could in turn again be brought into a position blocking the flow.

In particular, in the case of a suitable combination of a fan and a mixing device designed as Venturi mixer, the speed of rotation-dependent pressure fluctuations via the 1^{st} order or blade arrangement of the impeller is measurable on the sensor. Thus, for example, during a flushing phase of the gas boiler, a plausibility check can be performed as to whether the impeller is still firmly connected to the motor or to a hub of the motor.

A flushing phase is understood to be a phase during the operation of the gas boiler where exclusively air flows through the mixing device and, in particular, into the burner. Thus, any fuel still possibly present is flushed out of the burner. The safety valve is preferably closed or in a position blocking the flow so that no fuel can flow during the flushing of the gas boiler.

Alternatively or additionally, another advantageous development of the method provides that the differential pressure course is detected with the safety valve closed and in particular during the flushing of the gas boiler. Thus, in the mixing device, flow separations of the air flowing in from the air inlet occur, which lead to pressure fluctuations that can be detected by the pressure sensor. For this purpose, the safety valve can correspondingly be brought and/or actuated into a position blocking the flow. Also, at the same time, no combustion in the gas boiler is possible. Correspondingly, such a method procedure can preferably be carried out before a start or after an end of the combustion. According to the method, the evaluation electronics detects the differential pressure course and, from the frequencies of the differential pressure courses, determines an actual volume flow of the air through the mixing device as a characteristic value.

The evaluation electronics determines a target volume flow from the differential pressure determined by the sensor. From the low pressure generated by the volume flow, which can be detected by the sensor, for example, the volume flow of the air flowing through the mixing device can be determined as target volume flow by a corresponding calculation.

If the target volume flow has been determined or calculated from the differential pressure course, the evaluation electronics compares the actual volume flow and the target volume flow with one another and, in the case of a deviation beyond a predetermined tolerance value, recognizes an error.

The frequency of the pressure fluctuations generated by flow separation on the Venturi nozzle of the mixing device, preferably designed as a Venturi mixer, is directly dependent on the air volume flow. Thus, a conclusion as to the air volume flow can be drawn from the pressure fluctuations or from their frequency. The separation frequency can correspondingly be measured, in particular, during the flushing phase of the gas boiler and thereby an average of the measured pressure can be checked for plausibility, which correspondingly is preferably a Venturi suction pressure generated by the Venturi nozzle or low pressure.

Due to the fact that the actual volume flow is indirectly determined via the pressure fluctuation, a deviation from a volume flow through the mixing device detected via another sensor or another method can be recognized and thereby an error or a sensor error can also be recognized.

Additionally or optionally, according to a likewise advantageous design of the method, the evaluation electronics detects and evaluates a frequency of a pressure fluctuation detected by the sensor as a function of a mass flow or alternatively of a volume flow through the control valve. Here, in the case of a linear variation of the frequency, with at the same time a linear variation of the mass flow or possibly volume flow, the evaluation electronics recognizes a fluctuation of a fuel supply pressure as an error.

The fuel supply pressure can fluctuate, for example, through gas meters arranged upstream of the fuel inlet. This (load-dependent) fluctuation of the fuel supply pressure can correspondingly be recognized, and filter settings or control parameters of the control valve can be adapted.

Moreover, the evaluation electronics can detect the pressure fluctuations via the frequencies of the differential pressure course. It compares them with a heat output course of the gas boiler, and, if pressure fluctuations are independent of the heat output of the gas boiler, recognize a fluctuation of an air volume flow, caused by wind gusts, which can be an error. Here, a course of the pressure fluctuations over time is compared with a course of the heat output over time. If the pressure fluctuates independently of the heat output course, it is very likely that the pressure fluctuation is caused by an irregular flow of air and, for example, by wind gusts. Correspondingly, such a pressure fluctuation, which is independent of the heat output or of the heat output course, can be recognized as error, whereupon, for example, an error message can be output or stored.

Wind fluctuations can lead to fluctuations in the Venturi pressure or in the low pressure generated by the mixing device for suctioning the fuel and therefore can be measured with the sensor. Correspondingly, by a spectral consideration of the pressure fluctuations, an excessively strong wind, for example, excessively strong and/or excessively frequent wind gusts, can be recognized. On the basis of this, counter-measures can also be initiated. Here, such a counter-measure can be, for example, a limitation of the modulation and/or an adaptation of filter settings as well as control parameters of the offset pressure controller.

According to an additional variant of the method, the gas boiler further comprises a burner designed to combust the fuel-air mixture, so that, when the fuel-air mixture is ignited, a pressure surge in the fuel-air mixture can occur, which, after the ignition, can be detected by the sensor as pressure fluctuations. According to the method, the evaluation electronics detects the pressure fluctuation and, by analysis of the differential pressure course determined by the pressure fluctuations, it detects the occurring pressure surge as a characteristic value.

If the developments requiring a burner are combined, this preferably involves a single burner and not multiple burners.

To the extent that errors characteristic values and tolerance values are described, they can in each case be different errors and values, so that, by means of the method, multiple characteristic values can be determined, compared with the respective target values taking into consideration respective tolerance values, and from these respective errors can be determined.

An additional aspect of the disclosure relates to a gas boiler designed to carry out a method according to the disclosure.

The above-disclosed features can be combined as desired provided that this is technically possible and they are not in contradiction with one another.

Other advantageous developments of the disclosure are characterized in the dependent claims or represented in further detail below together with the description of the preferred design of the disclosure in reference to the figure. The figure shows:

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an exemplary diagrammatic representation of a gas boiler.

### DETAILED DESCRIPTION

Example embodiments will now be described more fully with reference to the accompanying drawings.

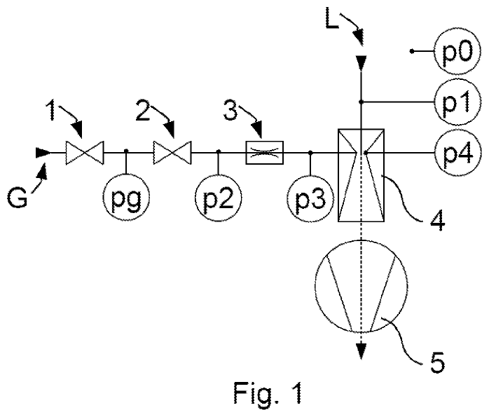

FIG. 1 diagrammatically shows a portion or a section of a gas boiler. A venturi mixer is represented as mixing device 4. Air at an air pressure p0 is suctioned from the environment through an air inlet L by a fan 5. In the mixing device 4, the inflowing air and a fuel (gas) flowing in through the fuel intake G are mixed to form a fuel-air mixture.

The fuel flowing in from the fuel intake G, which is in particular a gas, flows through a safety valve 1, a control valve 2 as well as the main flow restrictor 3. The safety valve 1 preferably comprises a passage position and a blocking position where the flow of the fuel through the safety valve 1 is blocked. The control valve 2 is designed for the closed-loop control of the volume flow of the fuel. Thus, the volume flow of the fuel through the control valve 2 to the mixing device 4 can be adjusted. By the adjustment or closed-loop control of the volume flow of the fuel through the control valve 2, the mixing ratio of the fuel-air mixture can thus be adjusted.

At least one differential pressure sensor is provided. It is designed to determine the differential pressure between the pressure p2 of the fuel upstream of the main flow restrictor 3 and downstream of the control valve 2 and a reference pressure. The reference pressure preferably is the environmental pressure p0 or a pressure p1 of the air in a supply line carrying air to the mixing device 4. For this purpose, the differential pressure sensor can include, for example, a respective pressure sensor or pressure transducer for detecting a respective pressure p0, p1, p2. Furthermore, additional pressure sensors for detecting the additional pressures pg, p3 and p4 can be provided. They can be used as reference pressure sensors to detect a reference pressure or for checking the plausibility of the pressures p0, p1, p2.

The fuel-air mixture is conveyed by the fan 5 to a burner of the gas boiler, which is not represented, where the fuel-air mixture is combusted.

By the method according to the disclosure, for example, the following functionalities can be implemented independently of one another or in combination with one another:

1. Detecting a thermoacoustic effect;

2. Detecting or checking the plausibility of a speed of rotation of an impeller of the fan;

3. Detecting a volume flow of the air through the mixing device when no fuel is flowing into the mixing device (flushing of the gas boiler with air);

4. Recognizing a fluctuating fuel supply pressure; and

5. Recognizing wind fluctuations.

Here, as described above, in each case a characteristic value can be detected and compared with a target value or limit value, wherein in each case a tolerance value can be taken into consideration. Depending on the comparison or when the characteristic value as actual value deviates excessively from the target value or exceeds or undershoots the limit value, an error can then be recognized or the conclusion that there is an error can be drawn.

The disclosure is not limited in its design to the preferred embodiment examples indicated above. Instead, a number of variants are conceivable, which use the represented solution even in designs of fundamentally different type.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for evaluating a sensor-detectable transient pressure difference on a gas boiler, the sensor is a differential pressure sensor or a mass flow sensor, the gas boiler comprises a mixing device, a fan, a main flow restrictor, control valve and safety valve, the mixing device mixes an inflowing fuel from a fuel inlet and inflowing air from an air inlet to form a fuel-air mixture, the fan suctions the fuel and the air through the mixing device, the main flow restrictor limits a mass flow of the fuel into the mixing device, the control valve is arranged upstream of the main flow restrictor for a closed-loop control of a mass flow of the fuel into a mixing unit, the safety valve, arranged upstream of the control valve, interrupts the mass flow of the fuel, the method comprising:
detecting a differential pressure between a pressure at a measurement point upstream of the main flow restrictor and downstream of the control valve and a reference pressure at a reference measurement point and transmitting it to evaluation electronics;
varying a heat output of the gas boiler according to a predetermined heat output course and/or is adjusted to a predetermined value;
detecting, during the variation of the heat output and/or when the heat output is adjusted to the predetermined value, a differential pressure course and transmitting it to the evaluation electronics;
evaluating, via the evaluation electronics, the differential pressure course over its time range and/or its frequency range; and
determining at least one characteristic value characterizing the differential pressure course and comparing it with a predetermined comparison value,
recognizing, if the characteristic value deviates from the comparison value beyond a predetermined tolerance value, an error of the gas boiler.

2. The method according to claim 1, wherein the gas boiler furthermore comprises a burner designed to combust the fuel-air mixture, so that a thermoacoustic effect, due to the combustion, can take place in the fuel-air mixture;
detecting pressure fluctuations during the combustion, with the evaluation electronics and analyzing the differential pressure course, and recognizing the occurring thermoacoustic effect as a characteristic value.

3. The method according to claim 2,
comparing the thermoacoustic effect with a predetermined limit value for the thermoacoustic effect as comparison value and, if the limit value is overshot, actuating the burner and/or the fan and/or the control valve and/or a safety valve, reducing the thermoacoustic effect and in particular reducing the thermoacoustic effect below the limit value.

4. The method according to claim 1, wherein the fan has an impeller and the impeller, by its rotation, generating pressure fluctuations of the fuel-air mixture, detected by the sensor; and
detecting the pressure fluctuations via the frequencies of the differential pressure course, and, from the frequencies of the differential pressure course, an actual speed of rotation of the impeller is determined as a characteristic value.

5. The method according to claim 4, wherein the fan comprises a motor that drives the impeller with a motor speed of rotation and the motor speed of rotation corresponds to a target speed of rotation of the impeller, and
comparing the actual speed of rotation of the impeller as characteristic value with the target speed of rotation of the impeller as comparison value; and
recognizing that the impeller is not connected in a predetermined way to the motor, if the actual speed of rotation deviates from the target speed of rotation of the impeller beyond a predetermined tolerance value.

6. The method according to claim 1,
detecting the differential pressure course with the safety valve closed, so that, in the mixing device, flow separations of the air flowing in from the air inlet occur, which lead to pressure fluctuations that can be detected by the pressure sensor; and
detecting the differential pressure course, and, from the frequencies of the differential pressure course, determining an actual volume flow of the air through the mixing device as a characteristic value.

7. The method according to claim 6,
determining a target volume flow from the differential pressure determined by the sensor.

8. The method according to claim 7,
comparing the actual volume flow and the target volume flow with one another and, in the case of a deviation beyond a tolerance value, recognizing an error.

9. The method according to claim 1,
detecting and evaluating a frequency of a pressure fluctuation detected by the sensor as a function of a mass flow through the control valve,
wherein the evaluation electronics, in the case of a linear variation of the frequency with, at the same time, a linear variation of the mass flow, recognizing a fluctuation of a fuel supply pressure (pg) as an error.

10. The method according to claim 1,
detecting the pressure fluctuations via the frequencies of the differential pressure course, comparing them with the heat output course of the gas boiler, and, if pressure fluctuations are independent of the heat output of the gas boiler;
recognizing a fluctuation of an air volume flow (p1), caused by wind gusts, which can be an error.

11. The method according to claim 1, wherein the gas boiler further comprises a burner designed to combust the fuel-air mixture, so that, when the fuel-air mixture is ignited, a pressure surge in the fuel-air mixture can occur, which, after the ignition, can be detected by the sensor as pressure fluctuations, and
detecting the pressure fluctuation and the occurring pressure surge as a characteristic value by analysis of the differential pressure course determined by the pressure fluctuations.

12. A gas boiler designed to carry out a method according to claim 1.
